(19) United States
(12) Patent Application Publication
(10) Pub. No.: US 2024/0287236 A1
(43) Pub. Date: Aug. 29, 2024

(54) USE OF MULTIBLOCK COPOLYMERS AS SACRIFICIAL MATERIAL IN A 3D PRINTING PROCESS

(71) Applicant: Arkema France, Colombes (FR)

(72) Inventors: Anne-Laure Brocas, LACQ (FR); Sylvie Cazaumayou, LACQ (FR)

(73) Assignee: Arkema France, Colombes (FR)

(21) Appl. No.: 18/572,066

(22) PCT Filed: Jun. 15, 2022
(86) PCT No.: PCT/FR2022/051148

§ 371 Date: Dec. 19, 2023

(30) Foreign Application Priority Data
Jun. 23, 2021 (FR) FR2106675
Oct. 7, 2021 (FR) FR2110633

(51) Int. Cl. C08F 293/00; B29C 64/40; B29K 55/00; B33Y 10/00; B33Y 70/00; C08F 212/08; C08F 220/06; C08F 220/18

(52) U.S. Cl. CPC C08F 293/005; B29C 64/40; C08F 212/08; C08F 220/06; C08F 220/1804; B29K 2055/00; B33Y 10/00; B33Y 70/00; C08F 2438/02

(57) ABSTRACT

The present invention relates to the use of multiblock copolymer compositions as sacrificial materials for 3D fused deposition modeling.

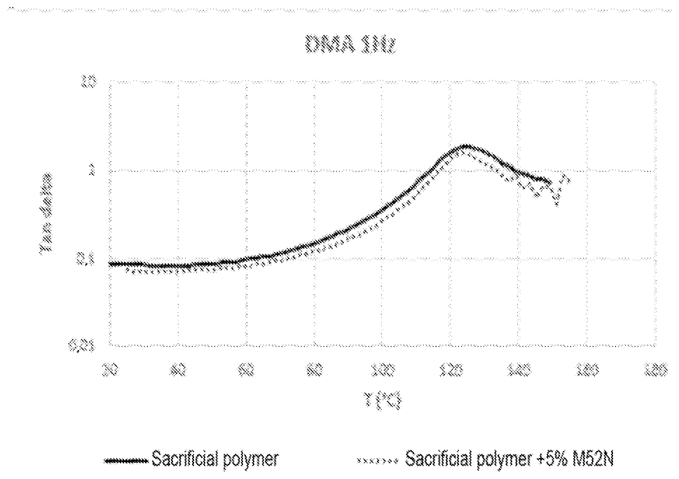

### CROSS-REFERENCE TO RELATED APPLICATIONS

This application is the U.S. National Phase of International Application No. PCT/FR2022/051148, filed Jun. 15, 2022, which claims priority to French Application No. 2110633, filed Oct. 7, 2021, and French Application No. 2106675, filed Jun. 23, 2021. The disclosure of each of these applications is incorporated herein by reference in its entirety for all purposes.

### FIELD OF THE INVENTION

The present invention relates to the use of multiblock copolymers or of multiblock copolymer compositions as sacrificial materials for 3D fused deposition modeling. Only block copolymers are used in this invention. This excludes any other polymer with an architecture not in the form of block copolymers.

Such materials exhibit rapid dissolution or dispersibility in a variety of solvents while combining thermomechanical properties ideal for making from them threads or rods that can be used in 3D printing (fused deposition modeling) for supporting polymers constituting the part to be manufactured, including polymers of high glass transition temperature (Tg), before being removed by dissolution in a solvent.

Three-dimensional printing (or 3D printing) makes possible the additive manufacturing (or AM) of a real object on the basis of a virtual object. It is based on cutting the 3D virtual object into 2D slices of very thin thickness. These thin slices are deposited one by one by fixing them onto the preceding slices, which reconstitutes the real object. The constituent materials of the object include plastics (in particular acrylonitrile butadiene styrene (or ABS) and polylactic acid (or PLA)), but also polyaryletherketones (PAEKs), polyetherimides (PEIs), wax, metal or ceramics. Examples of additive techniques are fused filament fabrication (FFF) and laser sintering.

Fused deposition modeling is a technique that consists in melting a filament through an extrusion nozzle. From this nozzle emerges a molten filament, with a diameter of the order of a millimeter. This thread is deposited in a line and bonds by remelting onto that which was deposited previously. This technique makes it possible to create parts made of proper material, which have mechanical and thermal characteristics and a stability identical to those of injection-molded thermoplastic parts, and are often lighter. In the case of polymers, for reasons of mechanical consolidation, this technique requires a support for the production of the parts, this support also being extruded conjointly. This construction support consists of a material other than that constituting the object created, this support being removed from said object when the process for constructing the latter is finished.

The construction support is generally a soluble or dispersible polymer composition corresponding to very precise specifications. Among the desired properties, in addition to the mechanical strength, the glass transition temperature of the copolymer, which has to be similar to that of the material to be printed, its thermal stability or its processability, the kinetics of dissolution or of dispersion in a variety of solvents and in particular water are of primary importance. The material must also be preserved well, when the dissolution or dispersion solvent is water. This latter characteristic is not always easy to create since the water-soluble or water-dispersible compositions and filaments can prove difficult to store in a humid atmosphere. Caking of the granules or bonding of the filaments to the spools due to the presence of ambient moisture during storage is observed.

### BACKGROUND OF THE INVENTION

This 3D printing technique requires support materials making possible the construction of complex parts; this is, for example, described in WO2010/045147.

The other water-soluble support materials include:
Polyvinyl alcohol.
Butenediol/vinyl alcohol BVOH copolymer.
(Meth)acrylic copolymers.

These support polymer compositions always comprise several copolymers, the role of which is to adjust solubility, mechanical properties or other parameters, resulting in more difficulties in development.

Among the other support materials soluble in other solvents, mention may be made, for example, of high-impact polystyrene (HIPS), which is soluble in limonene.

It is known in the prior art that the support must have a glass transition temperature (Tg) relatively close to that of the polymer constituting the object to be printed within an order of magnitude lower by 10° C. from the Tg of the polymer constituting the object to be printed.

Otherwise, the construction of the part to be printed does not take place correctly because the support material exhibits too much creep. This is explained, for example, in U.S. Pat. No. 5,866,058.

Surprisingly, the applicant has found that when block copolymers are used alone or in combination as sacrificial support material, this condition of Tg proximity of materials to be printed/support material is no longer necessary. This presents an advantage since there are far more possibilities for the definition of the other characteristics of the support polymer. It is thus easier to adjust the other parameters such as mechanical parameters or parameters of dissolution in aqueous medium, without worrying about the Tg of the sacrificial support polymer, provided that said Tg remain lower than that of the polymer constituting the object to be printed. Thus, with block copolymers the highest Tg of one of the blocks of which is, for example, 50° C., such block copolymers can be used as support material for constructing objects made of a material with a Tg ranging from 50° C. to 200° C. When combined with other block copolymers having at least one block the glass transition temperature (Tg) of which is less than 0° C. and at least one block the Tg of which is greater than 0° C., they offer a composition which also has very good mechanical properties.

This offers new possibilities for printing objects consisting of polyaryletherketones (PAEKs), polyetherimides (PEIs), polyamide-imide (PAI), polysulfone (PSU), poly(ethersulfone) (PES), poly(phenylene sulfide) (PPS), for which the choice of sacrificial support polymers is very limited and presents other disadvantages.

### SUMMARY OF THE INVENTION

The use of at least one multiblock copolymer (I) as sacrificial material in a process for 3D printing polymers the Tg of which is between 140 and 200° C. chosen from PEEK, PEKK, PEI, PAI, PSU and PPS, at least one multiblock copolymer (I) comprising at least one block consisting of i monomers Mᵢ linked together randomly, i being an integer ranging from 2 to 5, limits included, and at least one block consisting of j monomers Mⱼ linked together randomly, j being an integer ranging from 2 to 5, limits included, Mᵢ being selected from monomers A the Tg of the homopolymers of which is less than 0° C. and hydrophilic monomers B, the proportion by mass of A ranging from 80% to 95% and the proportion by mass of B ranging from 5% to 20%,
Mⱼ being selected from monomers C the Tg of the homopolymers of which is less than 0° C., monomers D the Tg of the homopolymers of which is greater than 25° C. and hydrophilic monomers E, the proportions by mass of the monomers C, D and E being respectively between 25-35%, 25-35% and 35-45%.

### BRIEF DESCRIPTION OF THE DRAWINGS

The FIGURE describes the DMA behavior of a sacrificial polymer (I) and of the combination thereof with a copolymer (II) (sacrificial polymer+5% M52N).

### DETAILED DESCRIPTION OF THE INVENTION

There is every reason to think that any type of monomer having the characteristics and the associated proportions in the block copolymers (I) as described in the summary of the invention result in a behavior favorable to solving the technical problems as described in the technological background.

This does not anticipate the chemistry used.

However, there is little chemistry that allows the preparation of such structures in block copolymers.

Reactive blocks may for example be prepared by polycondensation or ring opening such that other blocks can be linked up in a second step, with choices and proportions of the monomers in accordance with the summary of the invention.

The blocks can also be prepared by radical or anionic polymerization in the same way, that is to say block-by-block, such that other blocks can be linked up in steps, with choices and proportions of the monomers in accordance with the summary of the invention.

Among the preferred techniques, use will be made of controlled radical polymerizations since they make it possible to obtain block copolymers in sequential steps within the same process operation.

Mention may be made, in a non-limiting manner, of RAFT (Radical Addition Fragmentation Transfer) or NMP (Nitroxide Mediated Polymerization).

NMP will preferably be chosen, and preferably that employing the counter-radical N-tert-butyl-1-diethylphosphono-2,2-dimethylpropyl nitroxide. Such a counter-radical is widely described and used in the literature and employed by way of the alkoxyamine or polyalkoxyamines of 2-([tert-butyl[1-(diethoxyphosphoryl)-2,2-dimethylpropyl]amino]oxy)-2-methylpropionic acid.

As regards the monomers of the block copolymers (I) as described in the summary of the invention, the monomers A will be chosen from the following: alkyl (meth)acrylates, the alkyl having a linear or substituted C4-C18 chain and optionally containing oxygen, and in particular the following monomers: butyl acrylate (buA), 2-ethylhexyl acrylate (2EHA), methoxyethyl acrylate (MEA), lauryl methacrylate (lauMA), stearyl methacrylate (SMA).

The monomers B will be chosen from the following: acrylic acid (AA), methacrylic acid (MAA), styrene sulfonate, 2-acrylamido-2-propanesulfonic acid.

The monomers C will be chosen from the following:
alkyl (meth)acrylates, the alkyl having a linear or substituted C4-C18 chain and optionally containing oxygen, and in particular the following monomers: butyl acrylate (buA), 2-ethylhexyl acrylate (2EHA), methoxyethyl acrylate (MEA), lauryl methacrylate (lauMA), stearyl methacrylate (SMA).

The monomers D will be chosen from the following:
styrene (S); methyl methacrylate (MMA), acrylonitrile (AN), isobornyl acrylate.

The monomers E will be chosen from the following: acrylic acid (AA), methacrylic acid (MAA).

Preferably, A is butyl acrylate or 2-ethylhexyl acrylate, and more preferably butyl acrylate, B is acrylic acid or methacrylic acid, C is butyl acrylate or 2-ethylhexyl acrylate, and more preferably butyl acrylate, D is styrene, acrylonitrile, methyl methacrylate or isobornyl acrylate, and more preferably styrene or isobornyl acrylate, E is acrylic acid or methacrylic acid.

The polymers which can be printed using the sacrificial polymer compositions of the invention have glass transition temperatures (Tg) of greater than 50° C., among which mention may be made, in a non-limiting manner, of polylactic acid (PLA), acrylonitrile butadiene styrene (ABS), acrylonitrile styrene acrylonitrile (ASA), polyamides (PAs), polycarbonate (PC), polymethyl methacrylate (PMMA), copolyesters such as polyethylene terephthalate (PET), polybutylene terephthalate (PBT), polyolefins (PE, PP), and, for polymers with a high Tg of between 140 and 200° C., polyaryletherketones (PAEKs), denoted PEEK, PEKK, PEK, PEKEKK, PEEKK, PEKK depending on the aryletherketone sequences, polyetherimides (PEIs), polyamide-imide (PAI), polysulfone (PSU), poly(ethersulfone) (PES), or poly(phenylene sulfide) (PPS).

The use of the block copolymers as water-soluble support materials for high-temperature polymers such as PEEK, PEKK, PEI, PAI, PSU and PPS is particularly useful. The other polymers having lower Tg that are mentioned can also be printed, but other solutions already exist.

Thus, the preferences of the invention extend to the use of block copolymers as described in the summary of the invention for printing polymers the Tg of which is between 50 and 200° C., and preferably the Tg of which is between 140 and 200° C.

The block copolymers (I) as described in the summary of the invention are preferably di- or triblock copolymers, and more preferably diblock copolymers. In the definition of these copolymers, i can take values of between 2 and 5, preferably between 2 to 3, limits included, and more preferably 2. In the definition of these copolymers, j can take values of between 2 and 5, preferably between 2 and 3, limits included, and preferably 3.

They have a proportion by mass of the blocks consisting of the monomers of the family A and B ranging from 5% to 40% (block 1), preferably between 10% and 30%, and a proportion by mass of the blocks consisting of the monomers C, D and E ranging from 50% to 90% (block 2), preferably between 60% and 80%.

The balance of properties associated with the choices of the monomers selected in the invention enables these copolymers to be soluble in solvents chosen from water, DMSO, alcohols or also ketones in a non-limiting manner. Water is the preferred solvent in a pH range which may vary from 7 to 12 and preferably from 10 to 12.

In addition to the block copolymers (I) used in the invention, these may be combined with at least one block copolymer (II). Thus, the invention also relates to the use of the combination of copolymers (I) and (II) as sacrificial material composition in a 3D printing process.

The block copolymers (II) are preferably di- or triblock copolymers, and more preferably triblock copolymers. They are prepared with the same type of polymerization chemistry and process and according to the same type of preferences for polymerization chemistry and process as for block copolymers (I).

The copolymers (II) have at least one block the glass transition temperature (Tg) of which is less than 0° C. and at least one block the Tg of which is greater than 0° C.

As regards the monomers of the block copolymers (II), they will be chosen from the following:

For the blocks having a Tg of less than 0° C., butyl acrylate, 2-ethylhexyl acrylate and preferably butyl acrylate.

For blocks having a Tg of greater than 0° C., methyl methacrylate, styrene, acrylic acid, methacrylic acid, dimethylacrylamide, isopropylacrylamide, isobornyl acrylate, and preferably methyl methacrylate, dimethylacrylamide, isobornyl acrylate and isopropylacrylamide with proportions by mass in the case of dimethyl acrylamide or isopropylacrylamide of between 1% and 30% by mass and preferably between 5% and 15% relative to the total of (II).

When the dissolution or dispersion solvent is water, the compositions of the invention, in the presence or absence of the copolymer (II), exhibit very good dissolution at high pH values, for example 12, and far less good dissolution at pH 7. This provides an advantage because the spools of threads produced with these copolymers have better storage stability, in particular in a humid atmosphere.

The copolymers (I) as described in the summary of the invention have a weight-average molecular mass of between 80 000 and 150 000 g/mol and a dispersity index of between 1 and 3, and preferably between 1.5 and 2.5, measured by SEC using polystyrene standards.

They can be mixed with other block copolymers in order to adjust certain properties.

The block copolymers (II) have a weight-average molecular mass of between 50 000 and 150 000 g/mol and a dispersity of between 1 and 3, and preferably between 1.5 and 2.5, measured by SEC using polystyrene standards.

These block copolymers (II) can be used in the use of the composition in proportions ranging from 1% to 50%, preferably between 3% and 15%, by mass of the total weight of (I)+(II).

The glass transition temperatures (Tg) are measured by DSC.

The FIGURE describes the DMA behavior of a sacrificial polymer (I) and of the combination thereof with a copolymer (II) (sacrificial polymer+5% M52N).

### EXAMPLES

### Example 1—Synthesis of a Copolymer (I) P(BA-AA)-b-P(BA-S-MAA)

This example is directed to a diblock copolymer iMi-jMj, with i=2 and j=3, represented mMnN-block-oOpPqQ.

### Block 1:

M: butyl acrylate (buA), m=90% of block 1
N: acrylic acid (AA), n=10% of block 1.

### Block 2:

O: buA, o=30% of block 2.
P: styrene (S), p=30% of block 2
Q: methacrylic acid (MAA), q=40% of block 2.

The synthesis of this diblock copolymer takes place in two steps:
1^{st} block P(BA-AA) in bulk then stripping of the unreacted monomers.
2^{nd} block P(BA-S-MAA) in solvent.

### 1.1. Synthesis of the Block P(BA-AA)

This first block is synthesized by a bulk polymerization process using a reactor of the Ingenieur Büro type.

### Reactants:

butyl acrylate (BA)
   208.7 g
acrylic acid (AA)
   22.9 g
BlocBuilder®
   2.51 g

A number-average molecular mass of 27 000 g/mol at 70% conversion is targeted.

The reactants are weighed out and then mixed with magnetic stirring, and are then introduced into the reactor by vacuum pressure. The reactor is stirred (250 rpm). The medium is degassed by alternating three cycles of nitrogen pressure and vacuum. The polymerization takes place in three temperature stages: 105° C. for 60 min then 110° C. for 90 min. The polymerization time is 300 min. The conversion is monitored by dry extracts, with samples taken every hour. (150° C. thermobalance and 125° C. vacuum oven).

When the target conversion is achieved, the temperature is lowered to 80° C. Once the setpoint is reached, the equipment is gradually placed under vacuum and the unreacted monomers are distilled (recovery in liquid nitrogen traps). The system is left at 80° C. and under maximum vacuum for about 90 minutes, when the distillation is complete, the setpoint is lowered to 40° C., and, once this setpoint is reached, 160 g of toluene are introduced (by vacuum pressure) so as to dilute the medium. The system is left stirring for a few hours at 40° C. so as to thoroughly homogenize the solution. This solution is then recovered.

### 1.2. Synthesis of the Block P(BA-S-MAA)

The synthesis is performed in the solvent process, using an ethanol/toluene mixture having a mass ratio of 60/40. The synthesis is performed with 45% of solvent relative to the total feedstock.

A 30/30/40 mass ratio BA/S/MAA mixture is introduced.

A copolymer P(BA-AA)-b-P(BA-S-MAA) with a composition by mass of 30/70 with a 70% conversion of the 2^{nd} block is targeted.

The feedstock is prepared as indicated below:
1^{st} block diluted in ethanol: 154.8 g
BA/S/AMA: 154.8/154.8/206.4 (g)
Ethanol/toluene: 329/219.5 (g)
The molar masses (PS equivalent) of this copolymer are as follows:
   Mp=95000 g/mol
   Mn=53 000 g/mol
   Mw=95 000 g/mol
   PI=1.81

In examples 2 to 4 (inventions 2 to 4), iMi-jMj diblock copolymers, with i=2 and j=3, represented mMnN-block-oOpPqQ, are prepared with the same ratio of blocks and the same proportions of monomers under the same synthesis conditions as for example 1. In table 1, the following monomers are selected:

TABLE 1

| | | | | | | Tg1 | Tg2 |
|---|---|---|---|---|---|---|---|
| | M | N | O | P | Q | (° C.) | (° C.) |
| Invention 1 | BuA | AA | buA | S | MAA | −10 | 120 |
| Invention 2 | SMA | AA | buA | S | MAA | −12 | 120 |
| Invention 3 | 2EHA | AA | 2EHA | S | MAA | −15 | 110 |
| Invention 4 | buA | MAA | buA | AN | MAA | −2 | 115 |

The proportions m, n, o, p, q remaining identical to those of example 1. The polymers obtained have similar characteristics in terms of molecular masses which do not vary by more than 10% compared to those obtained in example 1.

### Example 5: Dissolution Tests

The tests are carried out until complete dissolution of a pellet of support material of the invention and of the Aquasis® 120 and 180 products available on the market.

The pellets are prepared by compression at 200° C. The dissolution of the pellets is effected at pH=7 and at pH=12 at a temperature of 60° C.

### Example 6: Filament Extrusion

Spools were formed directly from the materials of the invention.

The spinning is carried out on a single-screw “Labtech LBE20-30/C” extruder (screw diameter: 20 mm). A caterpillar haul-off is used to take off the rod at a constant speed (9.1-9.4 m/min).

The extruder and the gear pump are adjusted to 190° C.

The screw speed of the extruder is 30-34 rpm, with a pressure P=55 bar.

The commercial control products Aquasis® 120 and Aquasis® 180 are available in the form of spools of threads that can be used directly in a 3D printing device.

### Example 7: 3D Printing

The parts were printed on an “Original Prusa i3 MK3S+” 3D printer. Other available printers can be used. The sacrificial resin in the form of a filament according to the invention or the Aquasis® 180 control are printed at a temperature of 250° C. on a plate at 122° C. for the first layer and then 120° C. for the following layers at a speed of 40 mm/s. The layer heights are 0.2 mm and the infill is 100% concentric.

The sacrificial resin in the form of a filament according to the invention or the Aquasis® 120 control are printed at a temperature of 220° C. on a plate at 120° C. for the first layer and then 105° C. for the following layers at a speed of 10 mm/s. The layer heights are 0.2 mm and the infill is 100% concentric.

The resins of the polymers of the parts to be constructed are printed under the following conditions:
ABS, 3DFilTech: 250° C.; 10 mm/s.
PLA, eMotion TECH: 210° C.; 10 mm/s.
PEI: ThermaX PEI—Ultem 9085: 360° C.; 10 mm/s.
PEKK, ThermaX PEKK 3DXTech: 360° C.; 10 mm/s.

The parts constructed are 4 cm×1 cm×0.5 cm bars of a sacrificial polymer bar (invention and control) on which a bar of identical dimensions is constructed using the target polymer (PLA, ABS, PEKK, PEI, etc.).

### Example 8

Once the parts have been constructed, when this is possible depending on the use of the control sacrificial resins or the sacrificial resins of the invention with a given polymer to be printed, the whole is immersed in water at 60° C. at a pH of 7 or 12 and then the time for all of the sacrificial material to be dissolved is noted. When the test is judged impossible, this means that the part to be constructed does not conform to the desired 3D digital model.

The results of dissolution and 3D printing tests are given in table 2:

TABLE 2

| | | | polymers to be printed | | | |
|---|---|---|---|---|---|---|
| | T1 | T2 | PLA | ABS | PEKK | PEI |
| Invention | >120 | 70 | possible | possible | possible | possible |
| 1 | | | | | | |
| Invention | >120 | 60 | possible | possibles | possible | possible |
| 2 | | | | | | |
| Invention | >120 | 80 | possible | possible | possible | possible |
| 3 | | | | | | |
| Invention | >120 | 85 | possible | possible | possible | possible |
| 4 | | | | | | |
| Aquasis ® | 40 | 75 | possible | possible | impossible | impossible |
| 120 | | | | | | |
| Aquasis ® | 60 | 120 | impossible | impossible | possible | possible |
| 180 | | | | | | |

T1: Time in minutes, total dissolution at 60° C., water pH 7
T2: Time in minutes, total dissolution at 60° C., water pH 12

It can be seen that whatever the polymer to be printed in table 2, the sacrificial resins of the invention make it possible to support the polymer to be printed.

### Example 9

The mechanical properties of the sacrificial polymer of the invention 1 were evaluated with a tensile test, with or without the addition of copolymer (II).

The measurement is performed on a filament of length 14 cm and diameter 1.75 mm. The elongation at break is measured using a “Zwick Roell Z005” type instrument, with a 5 kN sensor, speed: 5 mm/min, distance between jaws=61 mm.

The copolymers (II) tested are commercially available under the brand Nanostrength® with the references M52N and M65N. These copolymers conform in terms of composition and molecular masses to the description given for the copolymers (II). They were added in an amount of 5% and 10% by mass.

Table 3 shows the evaluations carried out:

TABLE 3

| | % Elongation at break | % Elongation at break |
|---|---|---|
| | freshly extruded | t + 1 month |
| Sacrificial material | 40 ± 5 | 20 ± 2 |
| Sacrificial material + | 70 ± 6 | 68 ± 8 |
| 5% M52N | | |
| Sacrificial material + | 83 ± 25 | 80 ± 10 |
| 10% M52N | | |
| Sacrificial material + | 80 ± 17 | 75 ± 5 |
| 5% M65N | | |

It is found that the addition of copolymer (II) on the one hand improves the elongation at break, and on the other hand that this elongation is preserved after one month of storage.

The dissolution of some of the materials of example 9, with and without copolymer (II), was effected at 60° C. and pH 12 and shows that it is adversely affected only to a small degree when copolymer (II) is present, as shown in table 4.

TABLE 4

| | Time to dissolve 100% |
|---|---|
| | of sacrificial material |
| Sacrificial material (I) | 50 min |
| Sacrificial material (I) + | 55 min |
| 5% M52N (II) | |
| Sacrificial material (I) + | 60 min |
| 10% M52N (II) | |
| Sacrificial material (I) + | 60 min |
| 5% M65N (II) | |

The materials of examples 1 (I) and 9 (I+II) employing 5% M52N were examined by DMA (dynamic mechanical analysis). Curve 1 shows that the rheological behaviors of the two materials are very similar.

1. At least one multiblock copolymer (I) suitable as sacrificial material in a process for 3D printing polymers, the Tg of which is between 140 and 200°, chosen from PEEK, PEKK, PEK, PEKEKK, PEEKK, PEKK, PEI, PAI, PSU and PPS, wherein the at least one multiblock copolymer (I) comprises:
at least one block consisting of i monomers Mᵢ linked together randomly, i being an integer ranging from 2 to 5, limits included, and
at least one block consisting of j monomers Mⱼ linked together randomly, j being an integer ranging from 2 to 5, limits included,
wherein Mᵢ is selected from monomers A, the Tg of the homopolymers of which is less than 0° C., and hydrophilic monomers B, the proportion by mass of A ranging from 80% to 95% and the proportion by mass of B ranging from 5% to 20%,
wherein Mⱼ is selected from monomers C, the Tg of the homopolymers of which is less than 0° C., monomers D, the Tg of the homopolymers of which is greater than 25° C., and hydrophilic monomers E, the proportions by mass of the monomers C, D and E being respectively between 25-35%, 25-35% and 35-45%.

2. The at least one multiblock copolymer (I) as claimed in claim 1, wherein at least one block copolymer (II) is present in a proportion by mass of between 1% and 50% of the total weight of (I)+(II).

3. The at least one multiblock copolymer (I) as claimed in claim 1, wherein the at least one block copolymer (I) is a diblock copolymer or a triblock copolymer.

4. The at least one multiblock copolymer (I) as claimed in claim 3, wherein the block copolymer (I) is a diblock copolymer.

5. The at least one multiblock copolymer (I) as claimed in claim 4, wherein the diblock copolymer (I) has a proportion by mass of the blocks consisting of the monomers of the family A and B ranging from 5% to 40% (block 1) and a proportion by mass of the blocks consisting of the monomers C, D and E ranging from 50% to 90% (block 2).

6. The at least one multiblock copolymer (I) as claimed in claim 1, wherein the copolymer (II) has at least one block the glass transition temperature of which is less than 0° C. and at least one block the glass transition temperature of which is greater than 0° C.

7. The at least one multiblock copolymer (I) as claimed in claim 1, wherein the block copolymers are prepared by controlled radical polymerization.

8. The at least one multiblock copolymer (I) as claimed in claim 7, wherein the block copolymers are prepared by nitroxide-mediated radical polymerization.

9. The at least one multiblock copolymer (I) as claimed in claim 8, wherein the block copolymers are prepared by radical polymerization mediated by N-tert-butyl-1-diethylphosphono-2,2-dimethylpropyl nitroxide.

10. The at least one multiblock copolymer (I) as claimed in claim 8, wherein at least one block copolymer (I) consists of blocks 1 employing butyl acrylate and acrylic acid and of blocks 2 employing butyl acrylate, styrene and methacrylic acid.

11. The at least one multiblock copolymer (I) as claimed in claim 1, wherein at least one block copolymer (I) has a weight-average molecular mass of between 80 000 g/mol and 150 000 g/mol.

12. The at least one multiblock copolymer (I) as claimed in claim 2, wherein the copolymer (II) has a weight-average molecular mass of between 50 000 g/mol and 150 000 g/mol.

13. The use of the at least one multiblock copolymer (I) as claimed in claim 1 as sacrificial material in a process for 3D printing polymers.
